(19) United States
(12) Patent Application Publication
(10) Pub. No.: US 2003/0118683 A1
(43) Pub. Date: Jun. 26, 2003

(54) Tool

(76) Inventor: Hans Schreck, Burgwald-Bottendorf (DE)

Correspondence Address: FLYNN THIEL BOUTELL & TANIS, P.C., 2026 RAMBLING ROAD, KALAMAZOO, MI, 49008-1699, US

(21) Appl. No.: 10/324,751

(22) Filed: Dec. 19, 2002

(30) Foreign Application Priority Data
Dec. 20, 2001 (DE) 201 20 670.6
Jan. 11, 2002 (DE) 202 00 379.5

(51) Int. Cl. B29C 37/00; B29C 33/00

(52) U.S. Cl. 425/172; 164/150.1

(57) ABSTRACT

The maintenance of tools having functional parts located in their interior is facilitated considerably if these functional parts can be permanently observed and monitored without the tool needing to be dismantled. For this purpose coverable recesses are provided in the body of the tool.

### DESCRIPTION

The invention relates to a tool for metal or plastic machining in complex design comprising a base body with built-in functional parts provided preferably interchangeably in cavities of the base body provided for that purpose, for example, an injection die for plastics or the like with inherently known channel guides, ejectors as well as guides and the like.

With such tools, the functional parts accommodated in their interior as mainly independent assemblies are generally individually interchangeable in order to avoid putting the entire tool out of service if it is otherwise still capable of functioning. Frequently such functional parts do not fail abruptly but gradually lose their operability with this not being able to be identified at the tool without dismantling it. If damage or wear is identified in good time, the expenditure for rectifying such defects could be kept within limits but instead of this, when these defects become obvious, considerably greater expenditure and higher costs are usually required to be able to restore the operability.

The object of this invention is thus to develop a tool of the type specified in detail initially such that these defects can be identified in good time and can be rectified in as short a time as possible to avoid subsequent damage.

The object is solved according to the invention by providing recesses leading outwards from the cavities in the base body and arranging these such that the built-in functional parts can be checked visually for mode of operation, operability, accuracy to size and the like in situ without dismantling the tool and without disturbing their function. By means of such a simple measure which can usually be implemented without special design difficulties, the components essential for the function of the tool and subject to persistent high stressing and continuous wear can be continually checked for their operability so that as soon as this is no longer completely ensured and the failure of the corresponding assembly is imminent, corresponding repair measures can be taken in good time. Regular inspections by opening the tool are thus no longer necessary, rather the tool is only dismantled if functional errors are actually notified. Thus, the maintenance costs for these usually very expensive tools are reduced quite considerably and their economic efficiency is improved enormously without expensive measuring devices and control measurements being required for this purpose.

Recesses open to the surroundings of the type according to the invention are actually avoided as far as possible in rough workshop practice so that the more sensitive components of the tool are not exposed to contamination, severe heat input and other environmental influences. The invention avoids such hazards by further making the recesses according to the invention covetable with a closure.

This closure is best designed in detail as a cover flange wherein it is especially practical if this cover flange consists of a holding flange fixable to the base body and a viewing opening encompassed by the holding flange, which is covered, for example, by a pane of glass. In this fashion a visual inspection can easily be made at any time without the functional parts perceivable via the recesses being adversely effected. Such a closure is also suitable as an advertising vehicle for the tool manufacturer or the maintenance company because company names or trademarks applied thereon strike the eye on every inspection and are recollected as effective advertising. Intensive company advertising thus takes place at the same time beyond the actual formulation of the problem.

The invention is explained in detail subsequently with reference to an embodiment using the drawings wherein

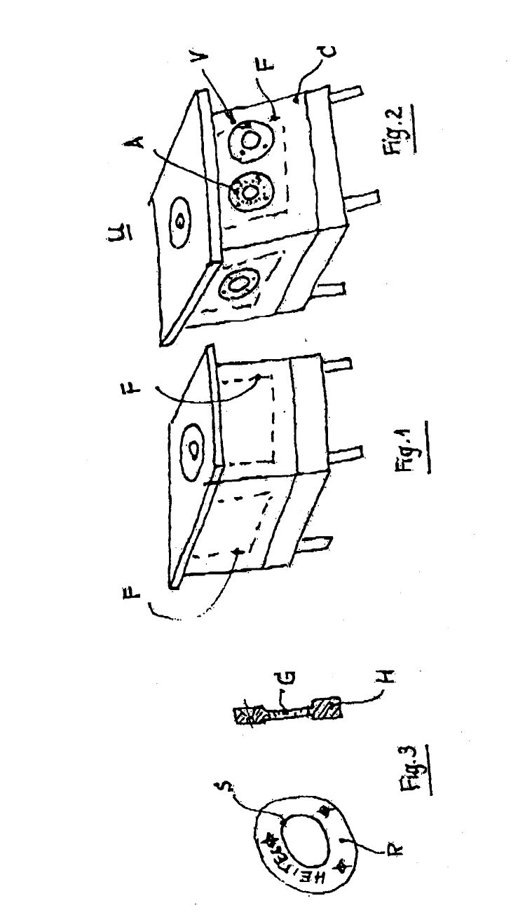

FIG. 1 is a schematic diagram of a generic tool according to the prior art,

FIG. 2 is a tool according to the invention in a representation corresponding to FIG. 1 and

FIG. 3 is a front and side view of a detail from FIG. 2.

FIG. 1 shows part of a plastic injection die in rough outline; the dashed lines indicate that inherently known functional parts F, for example, injection channels, valves, heaters, ejectors, guides or the like arc located in its interior and that these functional parts are neither visible nor accessible from the outside. Such a tool thus remains in use until signs of wear or disturbances to its functional parts are manifest on the implemented plastic injection products.

In the design of the same plastic injection die according to the invention as shown in FIG. 2, the functional parts F are each visible via one or a plurality of recesses A shown by dots in the body C of the tool; each recess A is covered by means of a closure V which shields the respective functional part P from the environment U.

The closures V are designed as a cover flange and are each in two parts and, as shown in FIG. 3, have a holding flange H for attachment to the tool, which surrounds a viewing opening S, encloses a glass pane G for the viewing opening S and serves to attach the closure V to the body C.

According to one embodiment, the glass pane can be constructed as an optical lens, especially as a wide-angle lens, so that the respective cavity can be inspected as completely as possible and especially to obtain a view into corner regions of the cavity.

A lighting device not shown in the figures can also be provided in the respective cavity which can preferably be switched on and off from outside.

The edge R of the holding flange H is also available as an advertising vehicle and can be used with a company name or a trademark especially for the manufacturer of the tool or a maintenance company.

List of reference symbols

| | |
|---|---|
| A | Recess |
| C | Body, base body |
| F | Functional part |
| C | Glass pane |
| H | Holding flange |
| R | Edge |
| S | Viewing opening |
| U | Environment |
| V | Closure |

1. A tool for metal or plastic machining in complex design comprising a base body (C) with built-in functional parts (F) provided preferably interchangeably in cavities of the base body (C) provided for that purpose, for example, an injection die for plastics or the like with channel guides and ejectors, characterised in that
in the base body (C) there are provided recesses (A) leading outwards from the cavities and arranged such that the built-in functional parts (F) can be checked visually for mode of operation, operability, accuracy to size and the like in situ without dismantling the tool and without disturbing their function.

2. The tool according to claim 1, characterised in that the recesses (A) are each coverable by means of a closure (V).

3. The tool according to claim 2, characterised in that the closure (V) is designed as a cover flange.

4. The tool according to claim 3, characterised in that the cover flange consists of a holding flange (H) fixable to the base body (C) and a viewing opening (S) surrounded by the holding flange (H).

5. The tool according to claim 4, characterised in that the viewing opening (S) is covered by a glass pane (G).

6. The tool according to claim 5, characterised in that the glass pane (G) is constructed as an optical lens, especially a wide-angle lens.

7 The tool according to one of claims 1 to 6, characterised in that a lighting device is provided in at least one of the cavities of the base body (C).

8. The tool according to claim 7, characterised in that the lighting device can be switched on and off from outside.

9. The tool according to one of claims 2 to 8, characterised in that the closure (V) serves as an advertising vehicle for the tool manufacturer or the maintenance company.
